(19) United States
(12) Patent Application Publication
(10) Pub. No.: US 2026/0022939 A1
(43) Pub. Date: Jan. 22, 2026

(54) MONOCULAR VISUAL PATH FOLLOWING

(71) Applicant: NEC Corporation Of America, Herzlia (IL)

(72) Inventor: Tsvi LEV, Tel-Aviv (IL)

(73) Assignee: NEC Corporation Of America, Herzlia (IL)

(21) Appl. No.: 18/779,165

(22) Filed: Jul. 22, 2024

(51) Int. Cl. G01C 21/20; G05D 1/646; G06T 7/12; G06T 7/13

(52) U.S. Cl. CPC G01C 21/20; G05D 1/646; G06T 7/12; G06T 7/13

(57) ABSTRACT

System and method for planar navigation for a moving platform utilizing computer vision techniques is disclosed herein. The method includes capturing with a monocular camera an image containing at least two distinct substantially vertical edges positioned around a waypoint, calculating the horizontal coordinate of the waypoint relative to the horizontal coordinates of the edges, and adjusting the moving platform's heading angle to maintain the said position of the navigation goal. The method includes tracking the pixel separation of the edges and terminating navigation of a segment responsive to the pixel separation exceeding a predetermined threshold.

### FIELD AND BACKGROUND OF THE INVENTION

The present invention, in some embodiments thereof, relates to autonomous vehicles and, more particularly, but not exclusively, to path following techniques.

The use of unmanned aerial and ground vehicles, commonly referred to as drones, has recently significantly expanded across numerous industries, including agriculture, surveillance, delivery services, and environmental monitoring. The ability to navigate autonomously is crucial for maximizing the efficiency and utility of drones. Traditional navigation systems often rely on multiple sensors, such as GPS, lidar, and stereo cameras, which can be costly, complex, and power-consuming.

Monocular vision-based path following presents a cost-effective and simpler alternative by using a single camera to capture images and derive navigational data. Such methods leverage advanced image processing algorithms to interpret the visual environment, enabling the drone to follow a predetermined path or autonomously generate a path based on the visual cues.

Despite the potential advantages, traditional path following vision-based methods often struggle with accuracy, real-time processing constraints and require significant computational resources. Among common weaknesses of traditional path following are requirements of environment preparation (for instance, plotting on the floor high-contrast lines to follow or setting up artificial landmarks such as QR codes or ArUco tags near key waypoints) and dependence on visual landmarks that may not exist along the desired path, or may be subject to frequent change (such as appearance or disappearance of recognized objects, opening and closing of doors and so on).

### SUMMARY OF THE INVENTION

According to an aspect of some embodiments of the present invention there is provided a method for planar path navigation of a moving platform, the method comprising: receiving a first video frame from a camera or a data interface; receiving a target pixel separation value from an external process; identifying and selecting in the first video frame two separate substantially vertical edges; determining the horizontal coordinates corresponding to the two selected substantially vertical edges in the first video frame; obtaining the relative horizontal coordinate of a waypoint and performing at each sensing iteration in a path segment: receiving a video frame from a camera or a data interface; determining the current horizontal coordinates of the two previously selected substantially vertical edges in the video frame; computing the current pixel separation value between the two previously selected substantially vertical edges in the video frame; responsive to determining that the current pixel separation value exceeds the target pixel separation value, terminating the path segment, and subsequently restarting or terminating the method; computing the navigational parameter and outputting the navigational parameter.

According to some embodiments of the invention, the method further comprises receiving a relaxation parameter from an external process and the navigational parameter in part comprises the relaxation parameter.

According to some embodiments of the invention, obtaining the relative horizontal coordinate of the waypoint comprises: receiving an absolute horizontal coordinate of the waypoint in the first video frame from an external process and calculating the relative horizontal coordinate of the waypoint.

According to some embodiments of the invention, the method further comprises receiving a current heading angle of the moving platform from an external process.

According to some embodiments of the invention, obtaining the relative horizontal coordinate of the waypoint comprises receiving an relative horizontal coordinate of the waypoint in the first video frame from an external process.

According to some embodiments of the invention, the navigational parameter comprises the motion direction horizontal coordinate for the current sensing iteration in the path segment.

According to some embodiments of the invention, the navigational parameter comprises the heading angle of the moving platform for the current sensing iteration in the path segment.

According to some embodiments of the invention, identifying and selecting in the first video frame two separate substantially vertical edges further comprises: performing a complete segmentation of the first video frame; performing on the contours or edges in the segmented video frame a Hough transform and identifying vertical edges; constructing a set of identified edge pairs and iterating over the set of identified edge pairs and performing in each iteration: determining the horizontal coordinates of the vertical edges in the pair; outputting to a navigational process instructions to aim the moving platform at a point equidistant between the two edges in the pair; measuring and storing the initial pixel distance between the two edges in the pair; receiving from a navigational process a first estimated distance to the edges in the pair; outputting instructions to apply a linear motion to move the platform forward by a pre-determined short distance, wherein the short distance is a percentage of the first estimated distance to the edges; measuring and storing the updated pixel distance between the two edges in the pair; calculating a second estimated distance between the two edges based on the stored initial pixel distance, the updated pixel distance, and the linear motion applied and responsive to the difference or the ratio of the first estimated distance and the second estimated distance satisfying a pre-determined criteria, outputting the two edges in the pair and terminating iteration, otherwise outputting instructions to apply a linear motion to move the platform backward by the pre-determined short distance.

According to some embodiments of the invention, constructing a set of identified edges further comprises removing identified vertical edges of length below a predetermined threshold length.

According to some embodiments of the invention, constructing a set of identified edges further comprises: sorting the list of vertical edges in ascending order based on their horizontal coordinates; performing for each edge in the sorted list of edges: pairing an edge with its immediate next edge in the sorted list; adding the consecutive edge pair to the set of identified edge pairs and outputting the plurality of adjacent edge pairs.

According to an aspect of some embodiments of the present invention there is provided a method for planar path navigation of a moving platform, the method comprising: receiving a first video frame from a camera or a data interface; receiving a target angular separation value from an external process; identifying and selecting in the first video frame a first substantially vertical edge and an adjacent second edge separated by a non-zero angle; receiving a time-dependent goal function of the horizontal coordinate of the first edge from an external process and performing at each sensing iteration in a path segment: receiving a video frame from a camera or a data interface; determining the current horizontal coordinate corresponding to the first edge in the video frame; computing the current angular separation value between the first and the second edges; responsive to determining that the current angular separation value exceeds the target angular separation value, terminating the path segment, and subsequently restarting or terminating the method; computing the heading angle of the moving platform for the current sensing iteration in the path segment and outputting the heading angle of the moving platform.

According to some embodiments of the invention, the method further comprises receiving a current heading angle of the moving platform from an external process.

According to some embodiments of the invention, the method further comprises receiving a relaxation parameter from an external process and wherein the navigational parameter in part comprises the relaxation parameter.

According to an aspect of some embodiments of the present invention there is provided a system comprising: a processor configured to execute stored executable instructions and a non-transitory computer readable medium storing executable instructions that, when executed by a processor, cause the computer system to perform a method for planar navigation of a moving platform, the method comprising: receiving a first video frame from a camera or a data interface; receiving a target pixel separation value from an external process; identifying and selecting in the first video frame two separate substantially vertical edges; determining the horizontal coordinates corresponding to the two selected substantially vertical edges in the first video frame; obtaining the relative horizontal coordinate of a waypoint and performing at each sensing iteration in a path segment: receiving a video frame from a camera or a data interface; determining the current horizontal coordinates of the two previously selected substantially vertical edges in the video frame; computing the current pixel separation value between the two previously selected substantially vertical edges in the video frame; responsive to determining that the current pixel separation value exceeds the target pixel separation value, terminating the path segment, and subsequently restarting or terminating the method; computing the navigational parameter and outputting the navigational parameter.

According to an aspect of some embodiments of the present invention there is provided a system comprising: a processor configured to execute stored executable instructions and a non-transitory computer readable medium storing executable instructions that, when executed by a processor, cause the computer system to perform a method for planar navigation of a moving platform, the method comprising: receiving a first video frame from a camera or a data interface; receiving a target angular separation value from an external process; identifying and selecting in the first video frame a first substantially vertical edge and an adjacent second edge separated by a non-zero angle; receiving a time-dependent goal function of the horizontal coordinate of the first edge from an external process and performing at each sensing iteration in a path segment: receiving a video frame from a camera or a data interface; determining the current horizontal coordinate corresponding to the first edge in the video frame; computing the current angular separation value between the first and the second edges; responsive to determining that the current angular separation value exceeds the target angular separation value, terminating the path segment, and subsequently restarting or terminating the method; computing the heading angle of the moving platform for the current sensing iteration in the path segment and outputting the heading angle of the moving platform.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well.

### BRIEF DESCRIPTION OF THE SEVERAL VIEWS OF THE DRAWING(S)

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of the principle of the dual-edge navigation approach, according to some embodiments of the invention;

FIG. 2 is an example illustration of a trajectory of a moving platform in an indoors environment, according to some embodiments of the invention;

FIG. 3 is an example illustration of dual-edge navigation in an outdoors environment, according to some embodiments of the invention;

FIG. 4 is an example workflow of the dual-edge navigation approach, according to some embodiments of the invention;

FIG. 5 is an example illustration of an adjacent-edge navigation in an outdoors environment, according to some embodiments of the invention;

FIG. 6 is an example workflow of the adjacent-edge navigation approach, according to some embodiments of the invention;

FIG. 7 is an example workflow of video frame preprocessing, according to some embodiments of the invention; and

FIG. 8 is an example workflow of edge pair selection, according to some embodiments of the invention.

### DESCRIPTION OF SPECIFIC EMBODIMENTS OF THE INVENTION

The present invention, in some embodiments thereof, relates to autonomous vehicles and, more particularly, but not exclusively, to path following techniques.

As used herein, the term AGV means autonomous ground vehicle, and the term UAV means unmanned aerial vehicle. An AGV or an UAV is confined to a horizontal plane and is not performing vertical movement beyond minor altitude adjustments for terrain following or altitude control stabilization.

As used herein, a camera means a digital optical monocular or a stereo camera that is fixed to point in the direction of movement and does not exhibit yaw, roll, or pitch deviations relative to the direction of movement, and wherein the lens parameters are fixed, preventing dynamic changes to the field of view during operation.

According to one of the methods disclosed in the present application, a moving platform such as an AGV or an UAV may be configured to follow a path by splitting the path into multiple sequential segments separated by waypoints, and identifying for each waypoint a visual anchor in the form of two vertical edges surrounding it that may subsequently be used for navigating the UAV or the AGV to the waypoint. A method for navigating a moving platform to a waypoint using such a dual-edge navigation approach is presented hereinbelow, as well as a method for identifying suitable edges. Additionally, a method for navigating a moving platform to a waypoint using a modified approach relying on a single vertical edge and tilted adjacent edge is presented hereinbelow. In a way of example, such a method may be used in the absence of identified vertical edges suitable for the dual-edge navigation approach.

As used herein, an edge can also refer to a localized small object with clear boundaries, such as a lamp, a small distant window, or a traffic sign. In such cases, one of the object's boundaries or its center of gravity, as determined by segmentation, may be considered as the edge.

The method described hereinbelow enables an UAV or an AGV to identify in a video feed a pair of vertical edges located on either side of a waypoint (and thereby enclosing it), and utilizing such a pair of edges as visual guides to move towards the waypoint until the angular or pixel distance between them exceeds a pre-determined threshold, thereby signifying that the UAV or the AGV has reached the waypoint, and enabling it to navigate to the next waypoint.

The method described hereinbelow is particularly useful for navigation in urban environments, as the corresponding visual scenery as a rule comprises a large number of objects possessing straight and sufficiently long edges.

The present invention offers several notable advantages and improvements over traditional navigation systems used in UAVs and AGVs. In contrast to systems relying on multiple sensors such as GNSS receivers, lidars, and stereo cameras, the technique disclosed herein is less expensive and does not require hardware components that may be challenging to obtain at scale. As the disclosed approach requires only one camera fixed on the body of an UAV or an AGV to derive navigational data, it significantly reduces the hardware costs and complexity involved in the design and operation of the UAV or the AGV, and furthermore allows to reduce power consumption and the total weight of equipment, which is crucial for extending the operational time of smaller autonomous vehicles. Equally important is the fact that in contrast to existing path following techniques the disclosed approach is capable of using arbitrary distinct linear edges and does not require stable visually robust landmarks in the general vicinity of waypoints.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Dual-Edge Navigation Approach

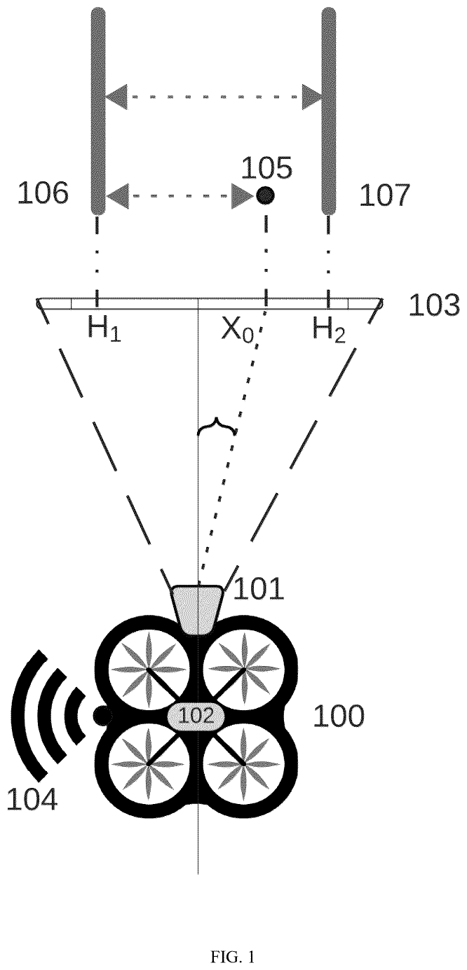

Referring now to the drawings, FIG. 1 illustrates the principle of dual-edge navigation approach. According to some embodiments of the invention, a moving platform 100 partially comprises a camera 101 and a computational unit 102. The camera 101 may capture a video frame 103 periodically, episodically, or responsive to a trigger event, and transmit it to the computational unit 102 for further processing.

In an embodiment, the moving platform 100 may perform translational motion in the direction observed by the camera 101. In another embodiment, the camera 101 is oriented along the longitudinal axis of symmetry of the moving platform 100.

In another embodiment, the moving platform 100 may perform rotational motion around a center of curvature. In another embodiment, the center of curvature may coincide with the center of mass of the moving platform 100, enabling the moving platform 100 to change solely its heading γ but not its distance relative to objects contained in a video frame 103. As used herein, γ is the heading angle of the moving platform 100 measured relative to a global frame of reference. In an example, γ may comprise the direction measured by a compass onboard the moving platform 100.

In an embodiment, the moving platform 100 comprises a quadcopter UAV. In another embodiment, the moving platform 100 comprises a steering AGV. In another embodiment, the moving platform 100 comprises a differential drive AGV.

In another embodiment, the computational unit 102 may execute an onboard navigational process.

In a further embodiment, the moving platform 100 may partially comprise a wireless network adapter 104. In an example, the network adapter 104 may enable the moving platform 100 to maintain connection with a remote operator or a server executing a remote navigational process.

In an embodiment, the computational unit 102 is configured to generate, via an onboard navigational process, or receive from a remote operator or a remote navigational process, a waypoint 105.

In an embodiment, responsive to receipt or generation of a waypoint 105, the moving platform 100 may execute a translational, a rotational motion or a combination thereof such that the waypoint 105 is contained within a video frame 103 subsequently captured by the camera 101.

In another embodiment, the computational unit 102 is configured to generate via an onboard navigational process or receive from a remote operator or a remote navigational process the X₀ horizontal coordinate in a video frame 103 of a waypoint 105.

In another embodiment, the computational unit 102 may request a subsequent waypoint 105 or its horizontal coordinate X₀ in a video frame 103 from an onboard navigational process, a remote navigational process, or an operator.

In another embodiment, the computational unit 102 retrieves from a non-transitory computer readable medium, generates via an onboard navigational process or receives from a remote operator or a remote navigational process numerical value for a target pixel separation parameter Y_{STOP}.

In another embodiment, the computational unit 102 retrieves from a non-transitory computer readable medium, generates via an onboard navigational process or receives from a remote operator or a remote navigational process numerical value for a relaxation parameter t. The parameter t is configured based on the specific characteristics of the moving platform 100 and its motion. A larger value of t results in quicker and potentially more abrupt corrections, which may lead to over-correction and oscillations. Conversely, a smaller value of t produces smoother corrections; however, if t is set too low, the moving platform 100 may not correct its course adequately.

In an embodiment, responsive to receiving a video frame 103 from the camera 101, the computational unit 102 detects and identifies substantially vertical edges 106 and 107 contained in the video frame 103 such that H₁≤X₀≤H₂, wherein H₁ is the horizontal coordinate of the edge 106 in the current video frame 103, H₂ is the horizontal coordinate of the edge 107 in the current video frame 103, and X₀ is the horizontal coordinate of the waypoint 105 in a video frame 103, together determining the parameter a of the waypoint 105. As used herein, a is the relative horizontal coordinate of the waypoint 105, determined as

$$α = \frac{{X}_{0} - {H}_{1}}{{H}_{2} - {H}_{1}} .$$

The computational unit 102 maintains tracking of the substantially vertical edges 106 and 107 if they are already initialized for the current waypoint 105, and initializes their tracking if they are not yet initialized for the current waypoint 105. Stated otherwise, in different video frames 103, the computational unit 102 selects vertical edges 106 and 107 corresponding to the same or substantially the same physical objects or features, unless a waypoint 105 or its horizontal coordinate X₀ is newly received or generated. In that case, the computational unit 102 may select vertical edges 106 and 107 corresponding to new physical objects or features.

In another embodiment, the computational unit 102 retrieves from a non-transitory computer readable medium, generates via an onboard navigational process or receives from a remote operator or a remote navigational process a numerical value of a such that 0≤α≤1. The computational unit 102 may subsequently compute the horizontal coordinate X₀=H₁+α·(H₂−H₁).

In an embodiment, responsive to receiving from the camera 101 a video frame 102 the computational unit 102 computes the current pixel separation value Yᵢ=|H₁−H₂| between the two edges 106 and 107 and the relative horizontal coordinate α of the waypoint 105.

In an embodiment, responsive to determining that Yᵢ≥Yₛₜₒₚ, the computational unit 102 concludes that the moving platform 100 has reached the waypoint 105 and sends a message to the onboard navigational process, remote navigational process, or remote operator. In a way of example, the onboard navigational process, responsive to receiving the message the onboard navigational process, remote navigational process, or remote operator may provide a subsequent waypoint 105.

In a further embodiment, responsive to absence of a subsequent waypoint 105 the computational unit 102 terminates the path following.

In an embodiment, responsive to determining that Yᵢ<Yₛₜₒₚ, the computational unit 102 computes and outputs to the onboard navigational process, remote navigational process, or remote operator a navigational parameter.

In an embodiment, the navigational parameter comprises the motion direction horizontal coordinate Xᵢ=((1−α)·H₁+α·H₂) for the current video frame 103.

In an embodiment, the navigational parameter comprises the heading angle γᵢ=γᵢ₋₁+τ·(Xᵢ−X₀) of the moving platform for the current video frame 103.

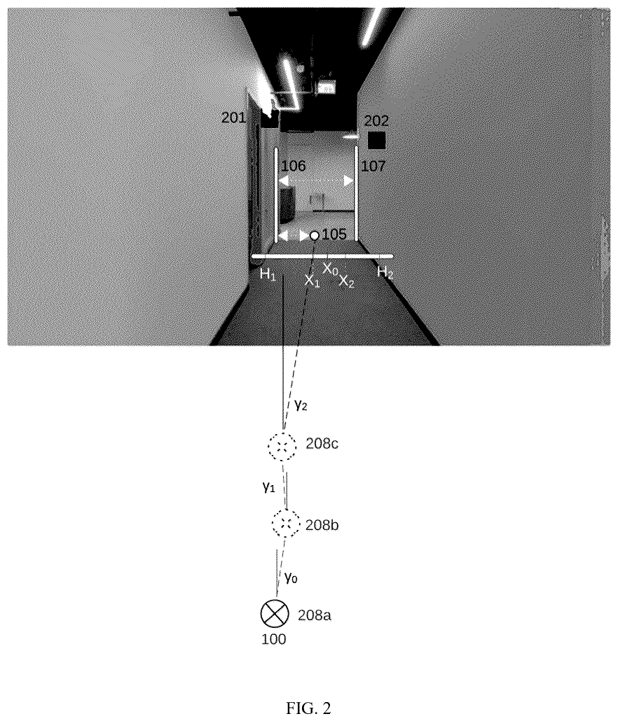

By the way of example, FIG. 2 illustrates a trajectory that a moving platform 100 may follow in an indoors environment. According to some embodiments of the invention, as the moving platform 100 starts in position 208a, the camera 101 captures a video frame 103, enabling the computational unit 102 to initialize tracking of the substantially vertical edges 106 and 107 of the wall segments 201 and 202, and to compute the value X₀ based on the configured value of α and the detected horizontal coordinates H₁ and H₂, and the value γ₀ based in part on the configured value of τ. The computational unit 102 subsequently outputs γ₀, enabling the moving platform 100 to move forward along the line connecting position 208a and position 208b. As the moving platform reaches position 208b, the camera 101 captures a video frame 103, maintains tracking of the substantially vertical edges 106 and 107 of the wall segments 201 and 202, and computes the value X₁ based on the configured value of a and the detected horizontal coordinates H₁ and H₂, and the value γ₁ based in part on the configured value of τ, X₀ and X₁. The computational unit 102 subsequently outputs γ₁, enabling the moving platform 100 to move forward along the line connecting position 208b and position 208c, wherein a next iteration may be executed, enabling the computational unit 102 to output γ₂.

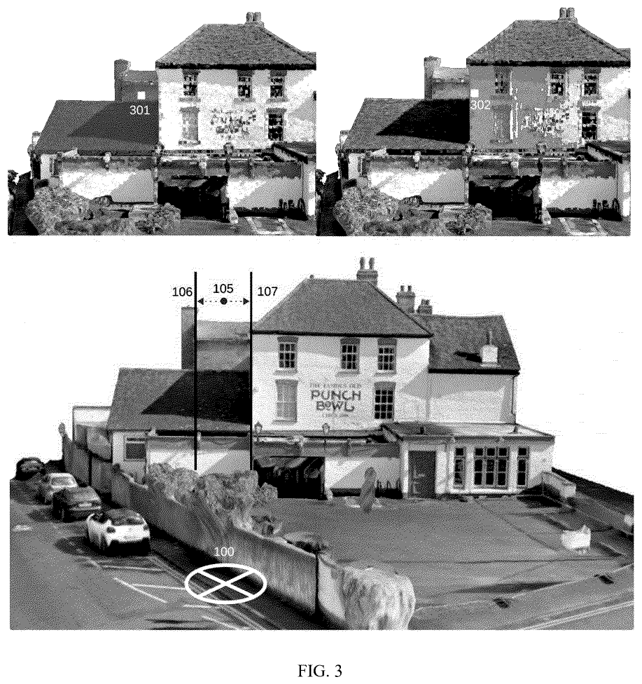

By the way of another example, FIG. 3 illustrates dual-edge navigation in an outdoors environment. According to some embodiments of the invention, the camera 101 captures a video frame 103, enabling the computational unit 102 to initialize tracking of the substantially vertical edges 106 and 107 of the wall segments 301 and 302, and to compute the value X₀ based on the configured value of a˜0.5, placing the waypoint 105 approximately equidistantly between the substantially vertical edges 106 and 107.

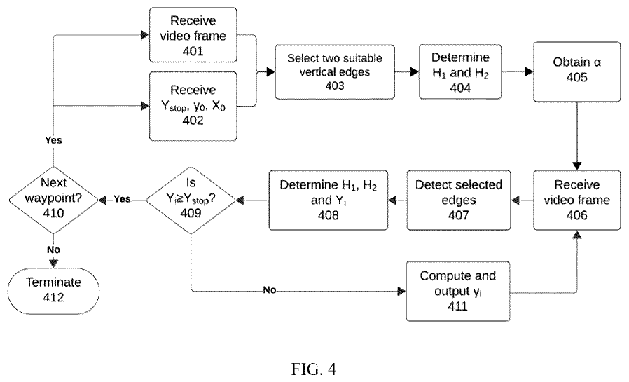

FIG. 4 illustrates an example workflow of the dual-edge navigation approach. According to some embodiments of the invention, the computational unit 102 receives 401 from a camera 101 a video frame 103, receives 402 from an external process the configuration parameters Yₛₜₒₚ, γ₀, X₀ relating to the moving platform 100 or the waypoint 105, performs 403 selection of two suitable substantially vertical edges 106 and 107, determines 404 the horizontal coordinates H₁ and H₂ of the substantially vertical edges 106 and 107, and computes the relative horizontal coordinate α of the waypoint 105. The moving platform 100 may subsequently move in the plane it currently occupies. The computational unit 102 iteratively receives 406 a new video frame 103 from the camera 101, detects 407 the selected substantially vertical edges 106 and 107 and determines 408 their horizontal coordinates H₁ and H₂ in the video frame 103, as well as their current horizontal separation value Yᵢ. Responsive to determining 408 that Yᵢ≥Yₛₜₒₚ, the computational unit 102 terminates the iteration and queries 410 availability of a subsequent waypoint 105, and otherwise computes and outputs 411 the current heading angle γᵢ, and continues iteration. Responsive to determining that there is a subsequent waypoint 105 available, the computational unit 102 restarts the navigational method, and otherwise terminates 412. The specification of an embodiment for selecting 403 two suitable vertical edges is detailed in section “Video frame preprocessing and edge selection” hereinbelow.

### Adjacent-Edge Navigation Approach

In the following section, a scenario is addressed in which no two visually separate suitable vertical edges can be detected, and therefore, the pixel separation value cannot be utilized as the stopping criterion. However, the presence of a single vertical edge adjacent to a tilted second edge, such as a tilted plane connected to a straight wall or door, is considered, wherein the angle between the edges may serve as a viable stopping criterion instead. For directional guidance, the position of a single vertical edge is employed, with a time-varying target function applied to its value rather than a fixed constant.

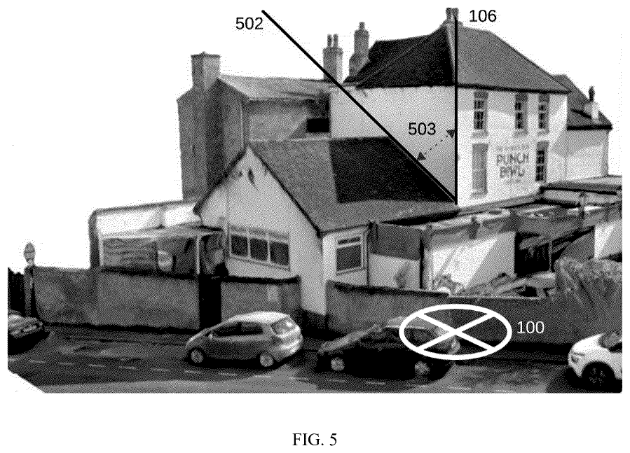

By the way of example, FIG. 5 illustrates adjacent-edge navigation in an outdoors environment. According to some embodiments of the invention, the camera 101 captures a video frame 103, enabling the computational unit 102 to initialize tracking of a substantially vertical edge 501 and a tilted edge 502, separated by an angular distance 503.

In an embodiment, responsive to receiving a video frame 103 from the camera 101, the computational unit 102 detects and identifies a substantially vertical edge 106 and an adjacent edge 502 separated by an angle β₀, wherein H₁ is the horizontal coordinate of the substantially vertical edge 106 in the current video frame 103. The computational unit 102 receives a time-dependent goal function X₀ (t), representing the desired horizontal coordinate of the substantially vertical edge 106 for the assumed or maintained motion speed. The computational unit 102 maintains tracking of the edges 106 and 502 if they are already initialized for the current waypoint 105, and initializes their tracking if they are not yet initialized for the current waypoint 105. Stated otherwise, in different video frames 103, the computational unit 102 selects vertical edges 106 and 502 corresponding to the same or substantially the same physical objects or features, unless a time-dependent goal function X₀ (t) is newly received or generated. In that case, the computational unit 102 may select edges 106 and 502 corresponding to new physical objects or features.

In an embodiment, responsive to receiving from the camera 101 a video frame 102 the computational unit 102 determines the current horizontal coordinate Xᵢ of the substantially vertical edge 106 and computes the current angular separation value βᵢ between the two edges 106 and 502.

In an embodiment, responsive to determining that βᵢ≥βₛₜₒₚ, the computational unit 102 concludes that the moving platform 100 has reached the waypoint 105 and sends a message to the onboard navigational process, remote navigational process, or remote operator. In a way of example, the onboard navigational process, responsive to receiving the message the onboard navigational process, remote navigational process, or remote operator may provide a subsequent waypoint 105.

In a further embodiment, responsive to absence of a subsequent waypoint 105 the computational unit 102 terminates the path following.

In an embodiment, responsive to determining that βᵢ<βₛₜₒₚ, the computational unit 102 computes and outputs to the onboard navigational process, remote navigational process, or remote operator a navigational parameter.

In an embodiment, the navigational parameter comprises the heading angle γᵢ=γᵢ₋₁+τ. (Xᵢ−X₀ (t)) of the moving platform for the current video frame 103 and current time t.

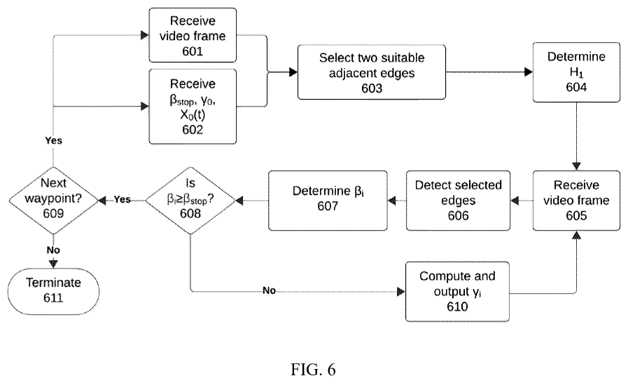

FIG. 6 illustrates an example workflow of the adjacent-edge navigation approach. According to some embodiments of the invention, the computational unit 102 receives 601 from a camera 101 a video frame 103, receives 602 from an external process the configuration parameters βₛₜₒₚ and γ₀, and a time-dependent goal function X₀(t) relating to the moving platform 100 or the waypoint 105, performs 603 selection of two suitable adjacent edges 106 and 502, and determines 604 the horizontal coordinate H₁ of the substantially vertical edge 106. The moving platform 100 may subsequently move in the plane it currently occupies. The computational unit 102 iteratively receives 605 a new video frame 103 from the camera 101, detects 607 the selected adjacent edges 106 and 502 and determines 607 their current horizontal separation value βᵢ in the video frame 103. Responsive to determining 608 that βᵢ≥βₛₜₒₚ, the computational unit 102 terminates the iteration and queries 609 availability of a subsequent waypoint 105, and otherwise computes and outputs 610 the current heading angle γᵢ, and continues iteration. Responsive to determining that there is a subsequent waypoint 105 available, the computational unit 102 restarts the navigational method, and otherwise terminates 612.

### Video Frame Preprocessing and Edge Selection

The previous sections have detailed the methods for planar navigation using a pair of edges as visual guides. The following section focuses on the preprocessing of video frames, specifically on the techniques employed to extract the aforementioned edges from video frames. This includes the initial steps necessary for edge detection and subsequent analysis.

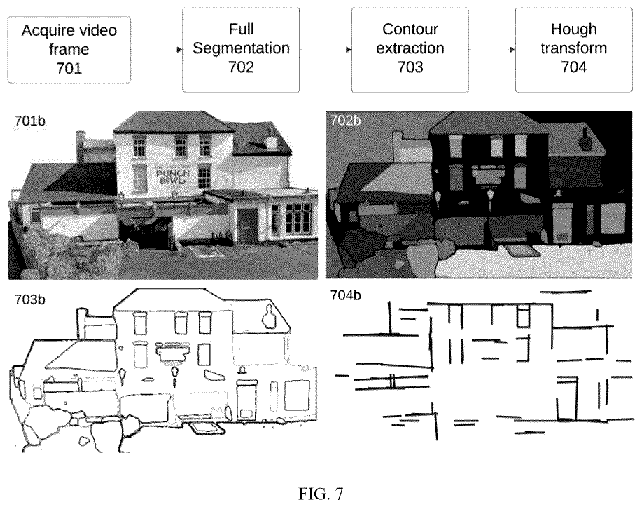

FIG. 7 illustrates an example workflow of video frame preprocessing and example results of the consecutive steps. According to some embodiments of the invention, the computational unit 102 acquires 701 a video frame 103 received from a camera 102. The computational unit 102 subsequently performs a complete segmentation 702 of the full video frame 103 without providing any foreground or background points. The computational unit 102 subsequently selects 703 contours or edges of identified segments, and applies 704 a Hough transform to the selected contours or edges to facilitate the identification of specific shapes such as vertical or horizontal edges. Example outputs of each step are illustrated as 701b, 702b, 703b and 704b, respectively.

Initialization of the method for path following disclosed hereinabove requires identification of the leading substantially vertical edges utilized in the method as visual guides.

In an embodiment, a method of measurement of the physical distance between the two edges with sufficient precision to differentiate the selected pair of edges from other possible pairs of edges within the field of view of the camera 101 is available to the computational unit 102. In a further embodiment, a method of measurement of linear motion in the forward direction aligned with the central axis of the field of view of the camera 101 is available to the computational unit 102. By the way of example, such a method may comprise dead reckoning or other methods. Due to the initial uncertainty of the exact position of a moving platform 100, it is not possible to accurately determine the specific location on an ellipse comprising the set of all suitable potential positions where the camera 101 observes a same pair of edges at the same angular size. However, as movement occurs, the change in angular size will correspond to the distance between the edges relative to the linear motion of the moving platform 100.

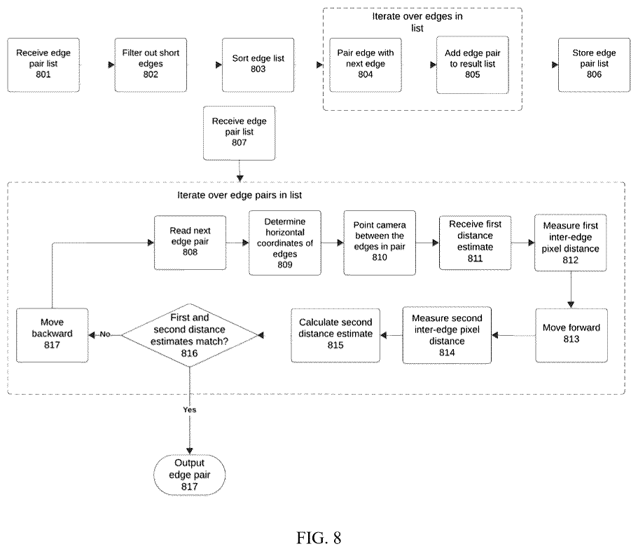

FIG. 8 illustrates an example workflow of edge pair selection. According to some embodiments of the invention, the computational unit 102 receives 801 a collection such as a list of vertical edges identified in the video frame 103 as disclosed hereinabove.

In an embodiment, the computational unit 102 subsequently removes 802 identified vertical edges of length below a predetermined threshold length LT.

In an embodiment, the computational unit 102 sorts 803 the list of vertical edges in ascending order based on their horizontal coordinates, iterates over each edge in the sorted list except the last edge, pairing 804 an edge with its immediate next neighbor in the sorted list, adding 805 the consecutive edge pair to a list of identified edge pairs, and stores 806 the list of consecutive edge pairs.

In an embodiment, the computational unit 102 receives 807 the list of consecutive edge pairs and iterates over each pair in the list, reading 808 an edge pair, determining 809 the horizontal coordinates of the vertical edges in the pair, outputting 810 to a navigational process instructions to rotate the moving platform 100 to point the camera 101 at a point equidistant between the two edges in the pair, receiving 811 from an external process a first estimated distance to the edges in the pair, measuring and storing 812 the initial pixel distance between the two edges in the pair, outputting 813 instructions to apply a linear motion to move the moving platform 100 forward by a short distance, measuring and storing 814 the updated pixel distance between the two edges in the pair, and calculating 815 a second estimated distance between the two edges based on the stored initial pixel distance, the updated pixel distance, and the linear motion applied. Responsive to the difference or the ratio of the first estimated distance and the second estimated distance satisfying a pre-determined criterion, the computational unit 102 may output 816 the two edges in the pair and terminate iteration, otherwise the computational unit 102 may output 817 instructions to apply a linear motion to move the platform backward by the short distance to maintain the identity of the plurality of edges currently observed by the camera 101 with the plurality of edges acquired 701 in the beginning of the initialization process.

In an embodiment, the short distance traveled during the edge selection process comprises a percentage of the first estimated distance to the edges.

In another embodiment, the pre-determined criterion comprises the ratio of the first estimated distance to the second estimated distance being bounded by predetermined numbers. By the way of example, such a pair of predetermined numbers may be (0.9, 1.1).

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for planar path navigation of a moving platform, comprising:
receiving a first video frame from a camera or a data interface;
receiving a target pixel separation value from an external process;
identifying and selecting in the first video frame two separate substantially vertical edges;
determining the horizontal coordinates corresponding to the two selected substantially vertical edges in the first video frame;
obtaining the relative horizontal coordinate of a waypoint; and
performing at each sensing iteration in a path segment:
receiving a video frame from a camera or a data interface;
determining the current horizontal coordinates of the two previously selected substantially vertical edges in the video frame;
computing the current pixel separation value between the two previously selected substantially vertical edges in the video frame;
responsive to determining that the current pixel separation value exceeds the target pixel separation value, terminating the path segment, and subsequently restarting or terminating the method;
computing the navigational parameter; and
outputting the navigational parameter.

2. The method according to claim 1, further comprising:
receiving a relaxation parameter from an external process; and
wherein the navigational parameter in part comprises the relaxation parameter.

3. The method according to claim 1, wherein obtaining the relative horizontal coordinate of the waypoint comprises:
receiving an absolute horizontal coordinate of the waypoint in the first video frame from an external process;
calculating the relative horizontal coordinate of the waypoint.

4. The method according to claim 1, further comprising:
receiving a current heading angle of the moving platform from an external process.

5. The method according to claim 1, wherein obtaining the relative horizontal coordinate of the waypoint comprises receiving an relative horizontal coordinate of the waypoint in the first video frame from an external process.

6. The method according to claim 1, wherein the navigational parameter comprises the motion direction horizontal coordinate for the current sensing iteration in the path segment.

7. The method according to claim 1, wherein the navigational parameter comprises the heading angle of the moving platform for the current sensing iteration in the path segment.

8. The method according to claim 1, wherein identifying and selecting in the first video frame two separate substantially vertical edges further comprises:
performing a complete segmentation of the first video frame;
performing on the contours or edges in the segmented video frame a Hough transform and identifying vertical edges;
constructing a set of identified edge pairs; and
iterating over the set of identified edge pairs and performing in each iteration:
determining the horizontal coordinates of the vertical edges in the pair;
outputting to a navigational process instructions to aim the moving platform at a point equidistant between the two edges in the pair;
measuring and storing the initial pixel distance between the two edges in the pair;
receiving from a navigational process a first estimated distance to the edges in the pair;
outputting instructions to apply a linear motion to move the platform forward by a pre-determined short distance, wherein the short distance is a percentage of the first estimated distance to the edges;
measuring and storing the updated pixel distance between the two edges in the pair;
calculating a second estimated distance between the two edges based on the stored initial pixel distance, the updated pixel distance, and the linear motion applied; and
responsive to the difference or the ratio of the first estimated distance and the second estimated distance satisfying a pre-determined criteria, outputting the two edges in the pair and terminating iteration, otherwise outputting instructions to apply a linear motion to move the platform backward by the pre-determined short distance.

9. The method according to claim 8, wherein constructing a set of identified edges further comprises removing identified vertical edges of length below a predetermined threshold length.

10. The method according to claim 8, wherein constructing a set of identified edges further comprises:
sorting the list of vertical edges in ascending order based on their horizontal coordinates;
performing for each edge in the sorted list of edges:
pairing an edge with its immediate next edge in the sorted list;
adding the consecutive edge pair to the set of identified edge pairs.
and outputting the plurality of adjacent edge pairs.

11. A method for planar path navigation of a moving platform, comprising:
receiving a first video frame from a camera or a data interface;
receiving a target angular separation value from an external process;
identifying and selecting in the first video frame a first substantially vertical edge and an adjacent second edge separated by a non-zero angle;
receiving a time-dependent goal function of the horizontal coordinate of the first edge from an external process; and
performing at each sensing iteration in a path segment:
receiving a video frame from a camera or a data interface;
determining the current horizontal coordinate corresponding to the first edge in the video frame;
computing the current angular separation value between the first and the second edges;
responsive to determining that the current angular separation value exceeds the target angular separation value, terminating the path segment, and subsequently restarting or terminating the method;
computing the heading angle of the moving platform for the current sensing iteration in the path segment; and
outputting the heading angle of the moving platform.

12. The method according to claim 11, further comprising:
receiving a current heading angle of the moving platform from an external process.

13. The method according to claim 11, further comprising:
receiving a relaxation parameter from an external process; and
wherein the navigational parameter in part comprises the relaxation parameter.

14. A system comprising:
a processor configured to execute stored executable instructions; and
a non-transitory computer readable medium storing executable instructions that, when executed by a processor, cause the computer system to perform a method for planar navigation of a moving platform, the method comprising:
receiving a first video frame from a camera or a data interface;
receiving a target pixel separation value from an external process;
identifying and selecting in the first video frame two separate substantially vertical edges;
determining the horizontal coordinates corresponding to the two selected substantially vertical edges in the first video frame;
obtaining the relative horizontal coordinate of a waypoint; and
performing at each sensing iteration in a path segment:
receiving a video frame from a camera or a data interface;
determining the current horizontal coordinates of the two previously selected substantially vertical edges in the video frame;
computing the current pixel separation value between the two previously selected substantially vertical edges in the video frame;
responsive to determining that the current pixel separation value exceeds the target pixel separation value, terminating the path segment, and subsequently restarting or terminating the method;
computing the navigational parameter; and
outputting the navigational parameter.

15. A system comprising:
a processor configured to execute stored executable instructions; and
a non-transitory computer readable medium storing executable instructions that, when executed by a processor, cause the computer system to perform a method for planar navigation of a moving platform, the method comprising:
receiving a first video frame from a camera or a data interface;
receiving a target angular separation value from an external process;
identifying and selecting in the first video frame a first substantially vertical edge and an adjacent second edge separated by a non-zero angle;
receiving a time-dependent goal function of the horizontal coordinate of the first edge from an external process; and
performing at each sensing iteration in a path segment:
receiving a video frame from a camera or a data interface;
determining the current horizontal coordinate corresponding to the first edge in the video frame;
computing the current angular separation value between the first and the second edges;
responsive to determining that the current angular separation value exceeds the target angular separation value, terminating the path segment, and subsequently restarting or terminating the method;
computing the heading angle of the moving platform for the current sensing iteration in the path segment; and
outputting the heading angle of the moving platform.
